(19) United States
(12) Patent Application Publication
(10) Pub. No.: US 2012/0299370 A1
(43) Pub. Date: Nov. 29, 2012

(54) CATERPILLAR-TYPE PROPELLING DEVICE FOR A TYRE-BEARING VEHICLE

(76) Inventor: Yury Alexandrovich Knyazev, Novosibirsk (RU)

(21) Appl. No.: 13/574,836

(22) PCT Filed: Jan. 17, 2011
(86) PCT No.: PCT/RU2011/000015

§ 371 Date: Jul. 24, 2012

(30) Foreign Application Priority Data
Jan. 25, 2010 (RU) 2010102093

(51) Int. Cl. B62D 55/084

(52) U.S. Cl. 305/6

(57) ABSTRACT

The invention relates to devices increasing the capacity of vehicles for cross-country travel, and specifically to caterpillar-type propelling devices. The special feature of the caterpillar-type propelling device for a tyre-bearing vehicle, the propelling device containing at least one caterpillar track, the internal surface of which is intended for interaction with the tyres of the vehicle, is that the caterpillar track has limited longitudinal bending internally and provides an internal size of the caterpillar track along the vertical to be greater than the height of the vehicle, and the caterpillar track length is selected to be sufficient to freely encompass the vehicle. The technical result provided by the proposed invention consists in the versatility of use of the propelling device by being capable of being installed virtually on any vehicle without altering and/or modifying the construction of the vehicle. Furthermore, the simplicity of constructing the propelling device, installing the latter on and removing the latter from a vehicle is increased. Furthermore, the proposed propelling device has small dimensions in the dismantled form and is reliable in operation.

### FIELD OF INVENTION

The invention is a type of devices, which is capable of augmenting a vehicles cross-country travel capacity, and, namely, it is a caterpillar-type propelling device.

### BACKGROUND OF INVENTION

A caterpillar-type propelling device made as two individual caterpillar tracks, which are mounted on a vehicle laterally on a unit of outboard wheels, which, in their turn, are mounted on the vehicle's main wheels (see U.S. Pat. No. 4,865,141, published on Sep. 12, 1989).

A drawback of this engineering solution is a certain need for a vehicle to be substantially improved to be given with caterpillar tracks, and a vehicle transversal size increase, as well, which diminishes sharply vehicle maneuverability in strict environments, such as forests, high density settlements and so on.

The most similar specimen considered close to the proposed invention is a caterpillar-type propelling device made as a pair of individual caterpillar tracks, which are mounted on a vehicle laterally immediately on its wheels (see U.S. Pat. No. 3,207,562, published on Apr. 1, 1963.

A drawback of that most similar specimen is that caterpillar-type propelling device is feasible to be used on those vehicles only, the lower edge of wheel arches of which is located higher than a line connecting the upper points of all wheel tyres. Moreover, the said propelling device design requires a special triangular-shaped mechanism with wheels in triangular vertices supporting a track in a point of its maximal bending.

### ESSENCE OF THE INVENTION

An engineering purpose of the proposed invention is creating a simple and dependable propelling device operating design, which might be used, practically, on any vehicle with no improvements in its design.

The problem of this sort is solved based on the fact that a feature of a caterpillar-type propelling device intended for a tyre-bearing vehicle comprises at least, a single caterpillar track, the inner surface of which is intended for interaction with the vehicle's tyres, is each said track is made having the longitudinal bending limited inwards and the track vertical inner size exceeding the vehicle height, and the track length is suitable to encompass a vehicle freely.

The caterpillar-type propelling device can be equipped with a pair of said tracks intended for the vehicle's right board and left board tyres, respectively. The caterpillar-type propelling device can be equipped with a single said track of a width suitable to have all vehicles' tyres mounted on. The said caterpillar track can be made of hingedly joined track links, or made hinge-free.

The track longitudinal bending limitation can be attained by making links equipped with some reciprocal turn limiters and/or links shape limiting any reciprocal turn.

The track can be made of a band; for this case, the track longitudinal bending is limited with a band material elastic feature.

The engineering outcome based on the proposed invention consists in providing a propelling device versatility, which makes it possible to mount the said device, practically, on any vehicle without any rework and/or its design improvements. For the case, its design, mounting and dismantling easiness rise on a vehicle. Further, the proposed propelling device dismantled is of small dimensions, and it is dependable in operation.

### LIST OF DRAWINGS

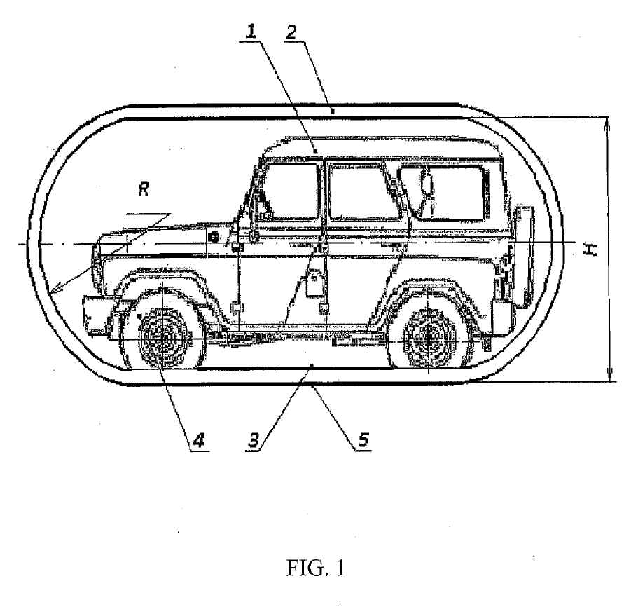

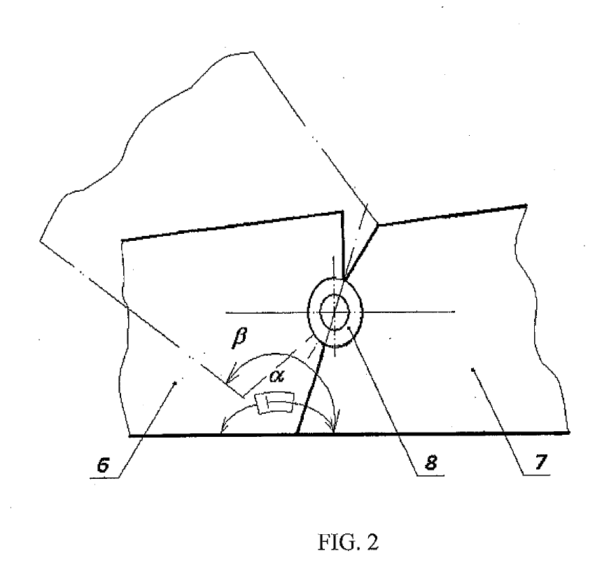

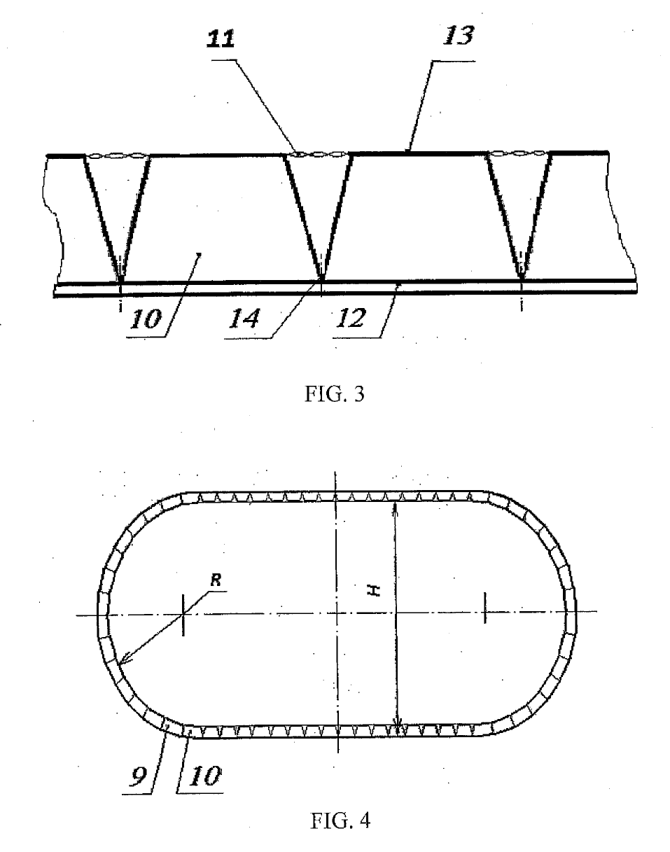

The invention is clear based on the drawings enclosed. FIG. 1 shows a device layout; it is mounted on a vehicle as an operating unit. FIG. 2 shows a caterpillar track piece made of hingedly joined links. FIG. 3 shows a hinge-free track piece made of links joined with some flexible couplers. Finely, FIG. 4 exhibits a hinge-free caterpillar track.

### INVENTION IMPLEMENTATION EXAMPLES

A caterpillar-type propelling device intended for a tyre-bearing vehicle (1), which is located inside a track encompassment, has a single or a pair of caterpillar tracks (2), the inner surface (3) of which opposing to strain is intended for interacting with the tyres (4) of a vehicle (1), and the outer surface (5) made of a solid elastic material opposing to contraction is intended for gripping a soil.

A caterpillar-type propelling device is capable of bearing two tracks (2) intended for the vehicle's right board and left board tyres, respectively. The tracks (2) can be joined with couplers. A caterpillar-type propelling device can possess the only track of width suitable to locate all vehicle's tyres. Each track (2) is made based on a limited longitudinal bending inwards to be attained by using different techniques. FIG. 2 exhibits a version of a track (2) made of hingedly joined links (6, 7) shaped so that a reciprocal turn around the hinge (8) is limited. The links can also possess some limiters of adjacent links (6, 7) reciprocal turn, which could be structurally inserted in the both links (6 and 7) bodies, either in one of them, or as an individual unit to be mounted in the hinge (8), and could be positioned both symmetrically and asymmetrically, and at various distances from the rotation center.

FIGS. 3 and 4 show a version of the track (2) made of the links (9) joined on a hinge-free basis with a flexible or another coupler, and shaped so that should the track bend outwards the adjacent links rest against each other with their sides. To limit any track bend inwards the flexible couplers (11) are used; they join the links (10) from the inner side. The links (10) could be trapezoid-shaped in the track (2) longitudinal section, the bigger bases (12) of which are located on the track (2) outer side and joined with the flexible couplers, or with any other technique of common knowledge; and the links smaller bases (13) watch inwards the track (2). The links (10) could have some other shapes possessing positions of some conditional rotation centers (14) of the mating links on the caterpillar track outer or inner sides.

The links (6, 7 and 10) feature a developed height, could be shaped, and consist of some assembled units. A movable joint of the adjacent links could be made so that the rotation centers are positioned asymmetrically relative to the links, i.e. in maximally lower or upper points. The angle a formed in the track longitudinal section between the outer sides of the adjacent links sets a functional condition of resistibility to a longitudinal bending inwards the track encompassment with one of its maximal value, namely, with the flat angle of 180°; and a condition of a track encompassment R arch stiffness with another angle β, its value lies within the β≦α≦180° range. The angle β limits an opposite bending value of the adjacent links and provides a minimally required height H of the caterpillar-type propelling device to have a vehicle located in it freely (see FIGS. 1 and 2).

The track (2) third version is a continuous band made of an elastic material. The longitudinal bending is limited with a band elasticity.

The longitudinal bending limitation provides a track (2) vertical inner size so that it exceeds the vehicle (1) maximal height, and the track (2) length is suitable to encompass the vehicle (1) freely.

The caterpillar-type propelling device operates in a following manner. A tyre-bearing vehicle (1), for instance, a motorcar is positioned onto a track (2) (tracks) inner surface so that the said motorcar occurs inside the track (2). When the motorcar's engine starts the torque transmits to the tyre-bearing (4) drive wheels which interact with the caterpillar tracks (2) making them move, which provides the motorcar's wheels with a continuous trackway in which wheels running resistance is considerably lower than on any soft soil.

Thus, the proposed device possesses a stably elastic design with regard to an operating longitudinal bending inwards the caterpillar track encompassment and a limitedly free one in opposite run making it possible for the caterpillar-type propelling device, as a whole, to have a hard design and to run actuated by the vehicle traction occurring as a support framework and a caterpillar-type propelling device.

1. A caterpillar-type propelling device intended for a tyre-bearing vehicle comprising, at least, a single caterpillar track, the inner surface of which is intended for interaction with the vehicle's tyres, and distinctive in that each said track is made having the longitudinal bending limited inwards and the track vertical inner size exceeding the vehicle height, and the track length is suitable to encompass the vehicle freely.

2. The caterpillar-type propelling device set forth in claim 1, comprising a pair of said tracks intended for the vehicle's right board and left board tyres, respectively.

3. The caterpillar-type propelling device set forth in claim 1, comprising a single said track of a width suitable to have all vehicle's tyres mounted on.

4. The caterpillar-type propelling device set forth in claim 1, wherein the caterpillar track is made of hingedly joined track links.

5. The caterpillar-type propelling device set forth in claim 1, wherein the caterpillar track is made hinge-free.

6. The caterpillar-type propelling device set forth in claim 1, wherein the track longitudinal bending limitation is attained by making links equipped with some reciprocal turn limiters and/or links shape limiting any reciprocal turn.

7. The caterpillar-type propelling device set forth in claim 1, wherein the track is made of a band; the track longitudinal bending is limited with a band material elastic feature.
